(19) United States
(12) Patent Application Publication
(10) Pub. No.: US 2005/0083958 A1
(43) Pub. Date: Apr. 21, 2005

(54) Managing a queue in a shared memory

(75) Inventors: Nir Drori, Rchovot (IL); Mark Geyzer, Maale Adumim (IL); Yan Kravchenko, Netaniya (IL)

Correspondence Address: Fogg and Associates, LLC, P.O. Box 581339, Minneapolis, MN, 55458-1339, US

(73) Assignee: ADC Telecommunications Israel Ltd.

(21) Appl. No.: 10/785,347

(22) Filed: Feb. 24, 2004

Related U.S. Application Data
(60) Provisional application No. 60/512,579, filed on Oct. 17, 2003.

(51) Int. Cl. H04L 12/56

(52) U.S. Cl. 370/412

(57) ABSTRACT

Managing an ATM queue in a shared memory by setting a queue length limit associated with the queue to an initial value and increasing the queue length limit in response to an overflow condition.

### CROSS REFERENCE TO RELATED APPLICATIONS

This application is related to, and claims the benefit of the filing date of, U.S. Provisional Application No. 60/512,579 filed on Oct. 17, 2003.

### TECHNICAL FIELD

The following description relates to the transmission of asynchronous transfer mode (ATM) cells.

### BACKGROUND

Asynchronous transfer mode (ATM) data transfer is a communication technology in which fixed-size packets of data, known as “cells,” are transferred by a network device. Each ATM cell includes a 5-byte header and a 48-byte payload. A network device that includes ATM functionality typically routes cells among various ports included in the network device.

One approach to routing cells uses a shared memory. Incoming cells destined for various output ports are buffered into queues. For example, these queues can be first-in-first-out (FIFO) queues. Each queue is associated with a corresponding output port. All of the queues share a common shared memory. One way in which such a queue is implemented is using a linked-list data structure. Cells are taken from the queues for transmission out on an output port.

In such a shared memory approach, each of the output queues is allocated a portion of the shared memory. There are several approaches to managing output queues in a shared memory. In one approach, a given queue is allowed to grow until the queue has used the entire portion of the shared memory currently allocated to that queue. In other words, the length of the queue is allowed to grow until the queue's length reaches a “queue length limit” for that queue.

After a queue has reached its queue length limit, additional cells destined for the port associated with that queue are dropped. This is referred to as an overflow condition. Such an approach typically reduces the chance that a small number of output queues will occupy a large portion of the shared memory. If a small number of output queues occupy a large portion of the shared memory, the other output queues may not be able to acquire enough memory to function efficiently. Such a condition is sometimes referred to as “starving” the other ports.

In such an implementation, the queue length limit is static—it is set to a given fixed value during system startup and does not change during normal operation. Using a static queue length limit simplifies implementation of the shared memory functionality. However, in some applications, the nature of the ATM traffic and network setup may result in the burst size of the ATM traffic being larger than the static queue length limit. It is also may be the case that the rate at which cells arrive is greater than the rate at which cells can be transmitted on the output ports. In both cases, cells may be dropped and service provided on one or more ports may be degraded.

Typically, in such implementations, the static queue length limit can be adjusted, for example, by upgrading software or firmware used in the network device. However, the time required to implement such methods of adjusting the static queue length limit can lead to extended periods of degraded service.

### SUMMARY

In general, in one aspect, a method of managing a queue in a shared memory includes setting a queue length limit associated with a queue to an initial value. The method also includes increasing the queue length limit in response to a predetermined condition.

In general, in another aspect, an apparatus includes a storage medium tangibly embodying program instructions for managing a queue in a shared memory. The program instructions include instructions operable to cause at least one programmable processor to set a queue length limit associated with a queue to an initial value and increase the queue length limit in response to a predetermined condition.

In general, in another aspect, an asymmetric digital subscriber line interface unit includes an ADSL interface device adapted to receive and transmit data with at least one ADSL line and a TDM bus interface device adapted to receive and transmit data with at least one TDM line. The line interface unit also includes an ATM mapping device, in communication with the ADSL interface device and the TDM bus interface device, that maps ATM cells directly to the at least one TDM line. The line interface unit further includes a shared memory coupled to the ATM mapping device. The ATM mapping device is configured to set a queue length limit associated with a queue stored in the shared memory to an initial value and increase the queue length limit in response to a predetermined condition.

The details of one or more embodiments of the claimed invention are set forth in the accompanying drawings and description below. Other features, objects, and advantages of the claimed invention will be apparent from the description and drawings, and from the claims.

### DRAWINGS

FIG. 1 is a flow diagram of one embodiment of a method of managing an ATM queue in a shared memory.

FIGS. 2A-2B are schematic diagrams of an exemplary illustration of the operation of one embodiment of a method of managing an ATM queue in a shared memory.

FIG. 3 is a block diagram of one embodiment of an ADSL line interface unit.

FIG. 4 is a flow diagram of one embodiment of a method of managing an ATM queue in a shared memory.

Like reference numbers and designations in the various drawings indicate like elements.

### DETAILED DESCRIPTION

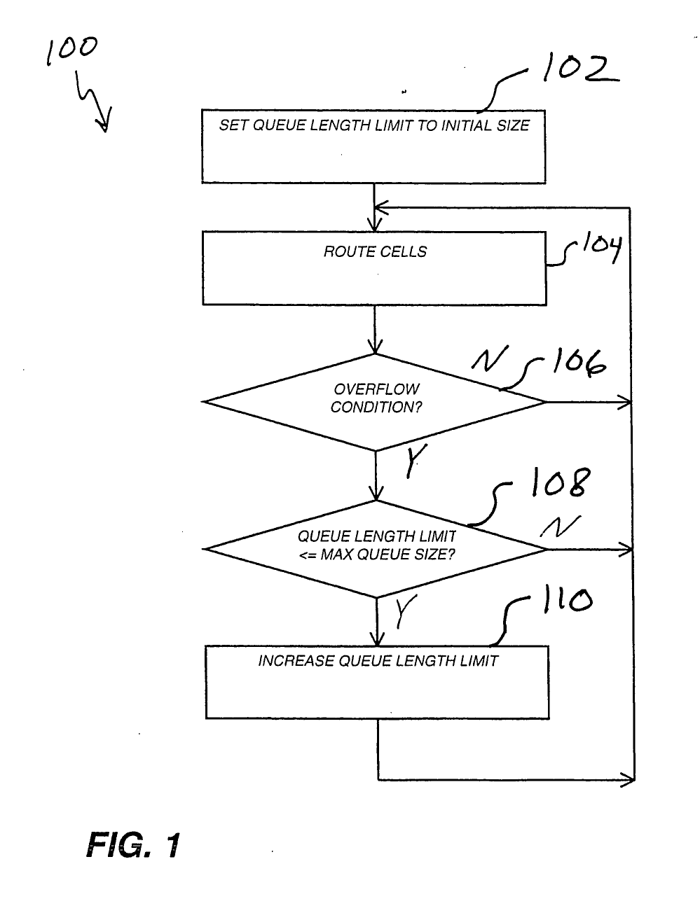

FIG. 1 is a flow diagram of one embodiment of a method 100 of managing a queue in a shared memory. For example, in one embodiment, method 100 is used to manage an ATM queue in a shared memory of a telecommunication device. Method 100 includes setting the queue length limit for a given output port to an initial size (block 102). For example, in one embodiment, the queue length limit can be set so that the queue can store 32 ATM cells. In such an embodiment, the queue length limit is set to the initial size during system startup, for example. In one implementation of such an embodiment, the initial size is stored in a memory and is retrieved from the memory during system startup in order to set the queue length to an initial size. The initial size is stored in the memory using, for example, an element management system. In one embodiment, the queue length limit for all ports using the shared memory is set, for example, to the same initial value.

Then, cells destined for that port are received, buffered, if necessary, and transmitted out on that port (collectively referred to as “routed”) (block 104) until a predetermined condition occurs for that port (checked in block 106). In one embodiment, the cells are ATM cells. In other embodiments, the cells are other types of packets. Moreover, in one embodiment, the predetermined condition is an overflow condition that occurs when the queue has reached its queue length limit. In another embodiment, the predetermine condition is a condition that indicates that an overflow condition is likely to occur (for example, the queue has reached a length that is queue length limit minus some margin).

When such a predetermined condition occurs for that port, the queue length limit is checked to determine if the queue length limit is less than or equal to a maximum queue length (checked in block 108). The maximum queue length is a parameter that specifies the maximum length any queue can reach. In one embodiment, the maximum queue length is the largest queue size that will not result in other ports being starved. In other embodiments, the maximum queue length is set to a different value.

If the queue length limit is less than or equal to the maximum queue length, the queue length limit for that output port is increased (block 110). For example, in one embodiment, the queue length limit for that port is increased by a fixed amount equal to 8 ATM cells. In other embodiments, the queue length limit for that port is increased by a fixed amount equal to 10 ATM cells. In one embodiment, the queue length limit for all ports using the shared memory is increased when the predetermined condition exists for any port. If the queue length limit is greater than the maximum queue length, then the queue length limit is not increased and routing of cells resumes (block 104).

In other embodiments, method 100 includes additional or alternate functionality. For example, in one such embodiment, setting the queue length limit for a given port to an initial size also includes setting the queue length limit associated with each port's queue. This initial size, in one embodiment, is set prior to normal operation of the device (for example, during system setup during installation). In other embodiments, this initial size is changed during normal operation of the device other than in response to the predetermined condition. For example, in such an embodiment, an operator uses an element or network management system coupled to the device to change the initial size during normal operation.

Also, although routing cells and determining if the predetermined condition has occurred for a given port are shown in the embodiment of FIG. 1 as sequential steps, in other embodiments this functionality is implemented in other ways. For example, in such embodiments, the determination as to whether the predetermined condition has occurred for a given port occurs before, after, or during the routing of cells. For example, in one embodiment, an interrupt service routine (described below) is used. In other embodiments, a memory location (for example, a register) or other item having information indicative of whether the predetermined condition has occurred for a particular queue is polled.

Moreover, in other embodiments, other processing occurs in the event that the queue length limit is greater than the maximum queue length. For example, in one embodiment, once the queue length limit for a given port is greater than the maximum queue length, a flag or other mechanism is used to avoid checking for, or performing any processing associated with, the predetermined condition for that port.

In one embodiment of method 100, the only adjustment to the queue length limit occurs when the initial queue length limit is set and when the queue length limit is increased in response to the predetermined condition (for example, an overflow condition). In such an embodiment, the status of the shared memory and the queues need not be continuously monitored in order to adjust the queue length limit, for example, in response to the availability of memory in the shared memory. Such an embodiment may be more easily implemented and may be more suitable for use in network devices that perform only limited ATM or other types of processing.

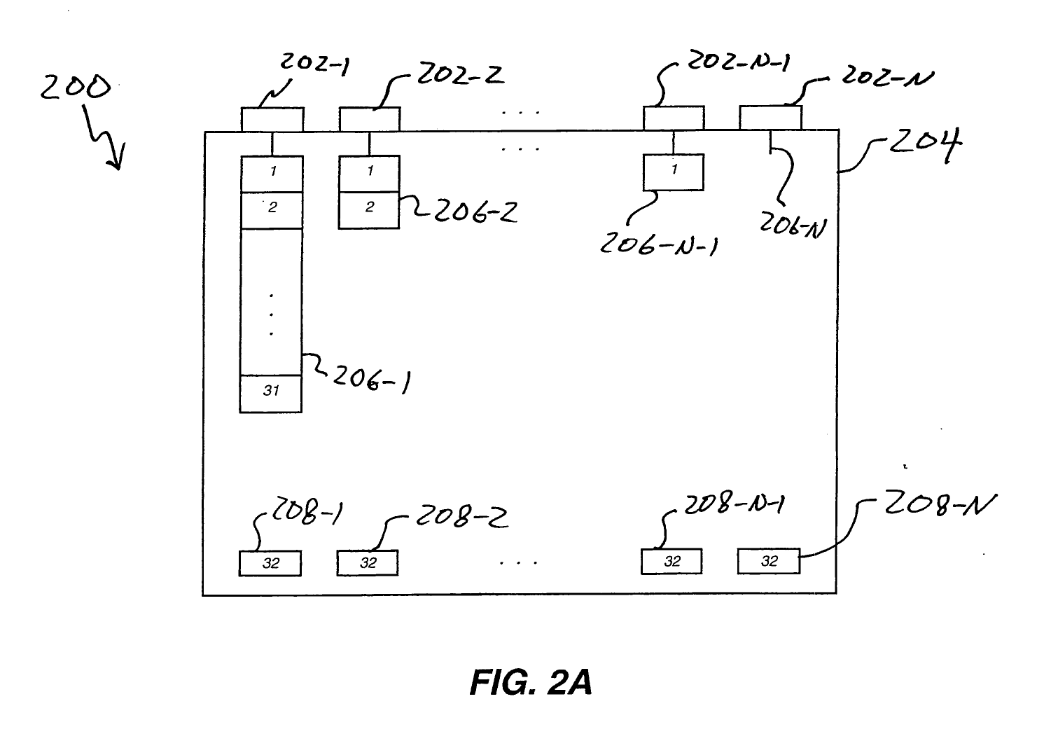

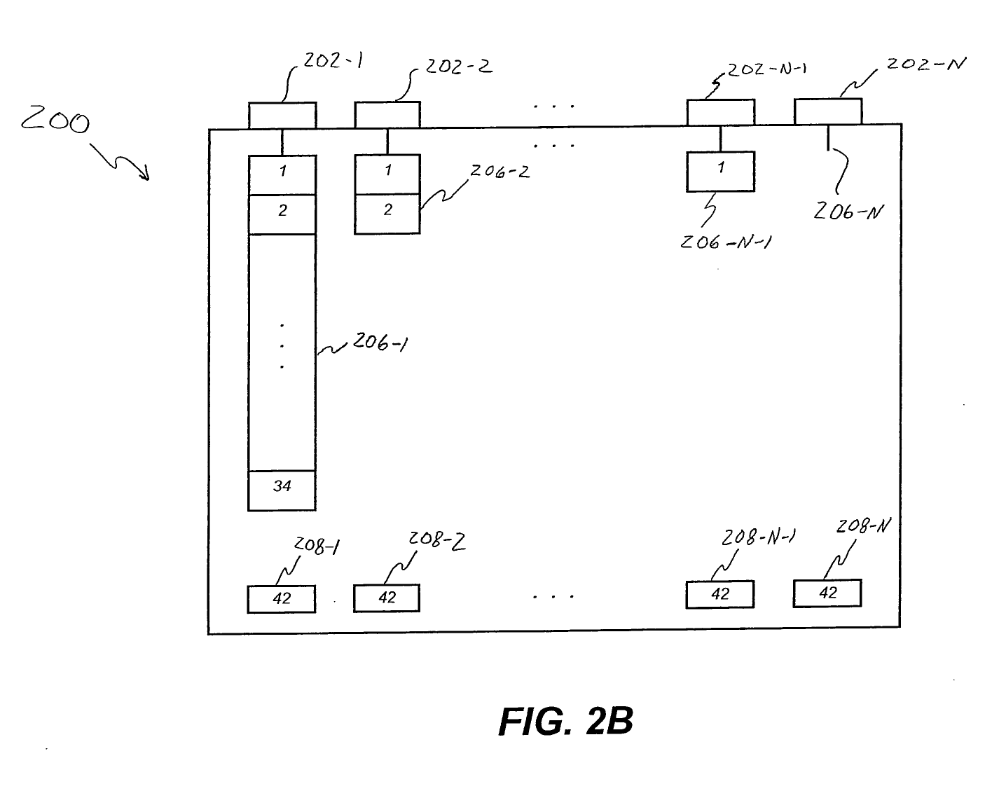

FIGS. 2A-2B are schematic diagrams of an exemplary illustration of the operation of one embodiment of method 100. A network device 200 has N output ports 202-1 through 202-N and a shared memory 204. The shared memory 204 is configured so that one of the N output queues 206-1 through 206-N is associated with one of the output ports 202-1 through 202-N, respectively. Each of the N output queues 206-1 through 206-N has a queue length limit 208-1 through 208-N, respectively. As shown in FIG. 2A, the queue length limit 208-1 through 208-N for each output queue 206-1 through 206-N is set to an initial value, 32 cells.

During operation of the network device 200, the output queues 206-1 through 206-N will typically contain differing amounts of cells. For example, as shown in FIG. 2A, output queue 206-1 contains 31 cells while output queue 206-2 contains 2 cells, output queue 206-N−1 contains 1 cell, and output queue 206-N contains no cells. After a predetermined condition (in this case, an overflow condition) associated with output queue 206-1 has occurred, the queue length limit 208-1 is increased, for example by 10 cells (as shown FIG. 2B). In the embodiment shown in FIGS. 2A-2B, the queue length limit for all N output queues 206-1 through 206-N are increased by 10 cells.

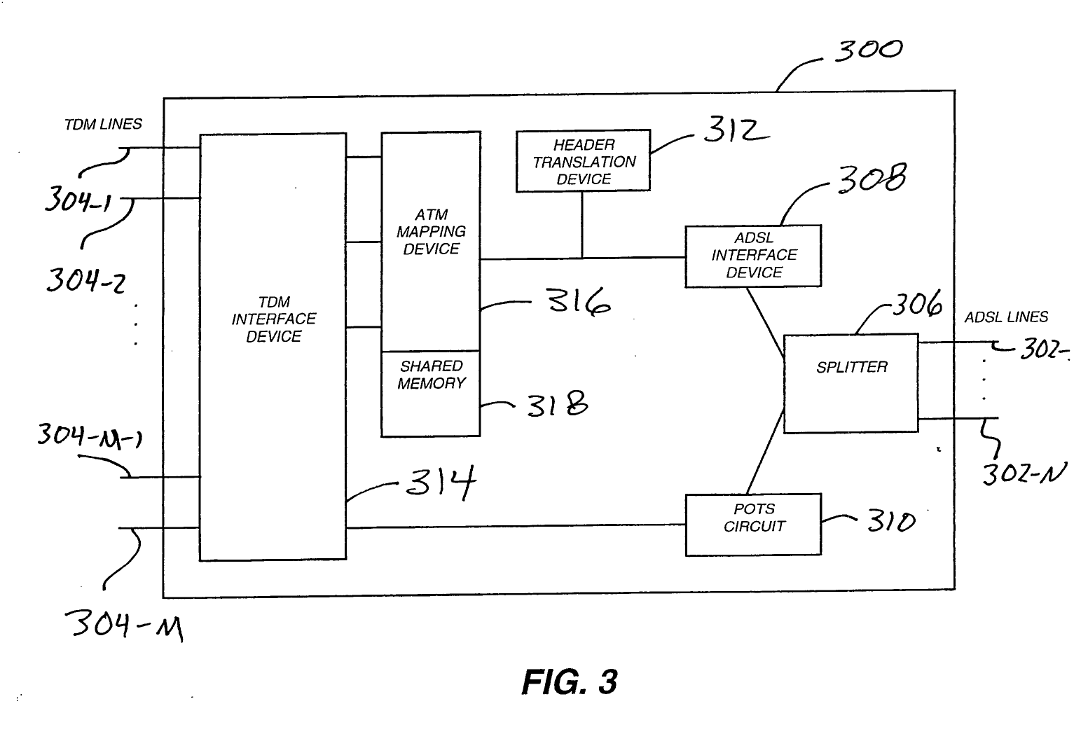

FIG. 3 is a block diagram of one embodiment of an ADSL line interface unit 300 on which embodiments of the methods described here can be implemented. ADSL line interface unit 300 directly maps ATM traffic from N subscriber ADSL lines 302-1 through 302-N onto M time division multiplexing (TDM) lines 304-1 through 304-M without performing ATM processing. In one embodiment, TDM lines 304-1 through 304-M are, for example, E1 or T1 lines. ADSL line interface unit 300 includes a splitter 306 coupled to an ADSL interface device 308 and a plain old telephone service (POTS) circuit 310. Data received on ADSL lines 302-1 through 302-N is separated by splitter 306 into ATM data and POTS data.

POTS data is transmitted to the POTS circuit 310 and then to a TDM interface device 314 where the POTS data is joined with the ATM data to be transmitted as TDM traffic over the TDM lines 304-1 through 304-M. The ATM traffic is received by the ADSL interface device 308 and based on the amount and type of ATM data (for example, high, low, or medium bandwidth) it is determined whether or not a translation header is required to transport the data. Data requiring a translation header is transmitted to a translation device 312 for translation header processing.

ADSL line interface unit 300 also includes an ATM mapping device 316. In one embodiment, ATM mapping device 316, for example, is an ATM inverse multiplexer and TDM physical layer interface. The ATM mapping device 316 maps ATM traffic to one or more of the TDM lines 304-1 through 304-M and maps TDM traffic onto one or more of the N ADSL subscriber lines 302-1 through 302-N. ATM mapping device 316 is coupled to a shared memory 318 for routing cells among the ADSL subscriber lines 302-1 through 302-N and the TDM lines 304-1 through 304-M. In one embodiment, the shared memory 318 is a part of the ATM mapping device 316; in other embodiments, the shared memory 318 is a separate memory such as a dynamic random access memory (DRAM). In one embodiment, the ATM mapping device 316 is implemented using the ASP chipset produced by Siemens. In another embodiment, the ATM mapping device 316 is implemented using an application-specific integrated circuit. One embodiment of an ADSL line interface unit 300 is the BROADACCESS N×E1 ADSL line interface card commercially available from ADC Teledata, Ltd. of Israel.

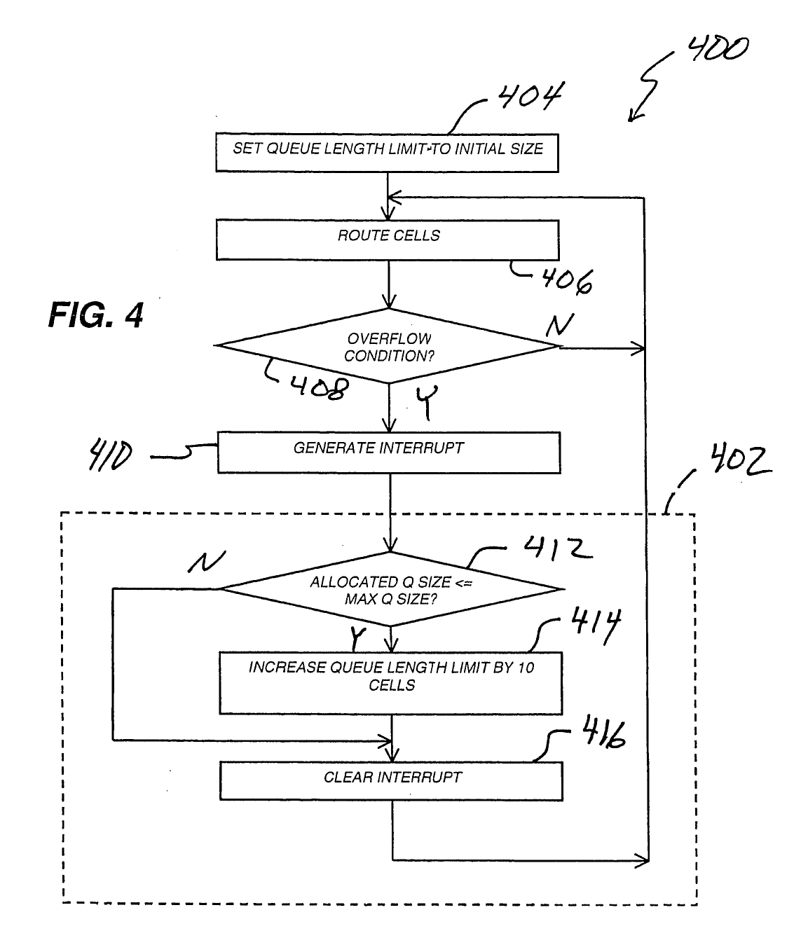

FIG. 4 is a flow diagram of one embodiment of a method 400 of managing an ATM queue in a shared memory. Method 400 uses an interrupt service routine (ISR) 402 to process an overflow condition (that is, the predetermined condition) associated with one of the queues in the shared memory. One implementation of such an embodiment is implemented, for example, using the ATM mapping device 316 of the ADSL line interface unit 300. Initially, (for example during system startup) the queue length limit for each port is set to an initial value, for example, 32 cells (block 404). Then, cells destined for the various ports are routed (block 406). When an overflow condition occurs for a given port (checked in block 408), an interrupt is generated (block 410).

Then control is passed to ISR 402. ISR 402 includes determining if the current queue length limit for that port is less than or equal to a maximum queue length (block 412). For example, in one embodiment, the maximum queue length is set to 64 cells. If the current queue length limit for that port is less than or equal to the maximum queue length, then the queue length limit for the port is increased by a selected number of cells (for example, 10 cells) (block 414) and the interrupt is cleared (block 416). In one implementation, the queue length limit for all ports using the shared memory is increased by the same number of cells. The ISR 402 completes and the routing of cells is resumed (block 406). If the current queue length limit is greater than the maximum queue length, the queue length limit for that port is not increased and the interrupt is cleared (block 416). The ISR 402 completes and the routing of cells is resumed (block 416).

In one implementation of method 400, the only adjustment to the queue length limit occurs when the initial queue length limit is set and when the queue length limit is increased in response to an overflow condition. In such an embodiment, the status of the shared memory and the queues need not be continuously monitored in order to adjust the queue length limit, for example, in response to the availability of memory in the shared memory. Such an implementation may be more easily implemented and may be more suitable for use in network devices that perform only limited ATM or other types of processing.

The methods and techniques described here may be implemented in digital electronic circuitry, or with a programmable processor (for example, a special-purpose processor or a general-purpose process such as a computer), firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. For example, although some of the embodiments described above process ATM cells, it is to be understood that in other embodiments, other types of packets or cells are processed. Accordingly, other embodiments are within the scope of the following claims.

1. A method of managing a queue in a shared memory, the method comprising:
setting a queue length limit associated with a queue to an initial value; and
increasing the queue length limit in response to a predetermined condition.

2. The method of claim 1, wherein the only adjustment to the queue length limit occurs when the initial queue length limit is set and when the queue length limit is increased in response to the predetermined condition.

3. The method of claim 1, increasing the queue length limit in response to the predetermined condition includes increasing the queue length limit by a fixed amount in response to the predetermined condition.

4. The method of claim 1, further comprising:
determining if the queue length limit is less than or equal to a maximum queue length;
wherein increasing the queue length limit in response to the predetermined condition includes increasing the queue length limit if the queue length limit is less than or equal to the maximum queue length.

5. The method of claim 1, wherein the predetermined condition is an overflow condition.

6. The method of claim 5, further comprising generating an interrupt in response to the overflow condition.

7. The method of claim 6, further comprising executing an interrupt service routine in response to the interrupt.

8. The method of claim 7, wherein the interrupt service routine increases the queue length limit in response to the overflow condition.

9. The method of claim 1, further comprise polling a memory location containing data indicative of whether the predetermined condition exists.

10. The method of claim 1, wherein the predetermined condition is a condition indicating that an overflow condition is likely to occur.

11. The method of claim 1, wherein the queue includes an ATM queue.

12. The method of claim 1, wherein increasing the queue length limit in response to the predetermined condition includes increasing the queue length limit for a plurality of queues in response to the predetermined condition.

13. Apparatus comprising a storage medium tangibly embodying program instructions for managing a queue in a shared memory, the program instructions including instructions operable to cause at least one programmable processor to:
set a queue length limit associated with a queue to an initial value; and
increase the queue length limit in response to a predetermined condition.

14. The apparatus of claim 13, wherein the only adjustment to the queue length limit occurs when the initial queue length limit is set and when the queue length limit is increased in response to the predetermined condition.

15. The apparatus of claim 13, wherein the program instructions operable to cause the at least one programmable processor to increase the queue length limit in response to the overflow condition further include program instructions operable to cause the at least one programmable processor to increase the queue length limit by a fixed amount in response to the predetermined condition.

16. The apparatus of claim 13, wherein the program instructions further include instructions operable to cause the at least one programmable processor to:
determine if the queue length limit is less than or equal to a maximum queue length;
wherein the instructions operable to cause the at least one programmable processor to increase the queue length limit in response to the predetermined condition increase the queue length limit if the queue length limit is less than or equal to the maximum queue size.

17. The apparatus of claim 13, wherein the predetermined condition is an overflow condition.

18. The apparatus of claim 17, wherein the at least one programmable processor generates an interrupt in response to the overflow condition.

19. The apparatus of claim 18, wherein the program instructions further include instructions operable to cause the at least one programmable processor to:
execute an interrupt service routine in response to the interrupt.

20. The apparatus of claim 19, wherein the interrupt service routine comprises the instructions operable to increase the queue length limit in response to the overflow condition.

21. The apparatus of claim 13, wherein the program instructions further include instructions operable to cause the at least one programmable processor to:
poll a memory location containing data indicative of whether the overflow condition exists.

22. The apparatus of claim 13, wherein the predetermined condition is a condition indicating that an overflow condition is likely to occur.

23. The apparatus of claim 13, wherein the queue includes an ATM queue.

24. The apparatus of claim 13, wherein the program instructions further include instructions operable to cause the at least one programmable processor to:
increase the queue length limit for a plurality of queues in response to the predetermined condition.

25. An asymmetric digital subscriber line interface unit, comprising:
an ADSL interface device adapted to receive and transmit data with at least one ADSL line;
a TDM bus interface device adapted to receive and transmit data with at least one TDM line;
an ATM mapping device, in communication with the ADSL interface device and the TDM bus interface device, that maps ATM cells directly to the at least one TDM line; and
a shared memory coupled to the ATM mapping device;
wherein the ATM mapping device is configured to:
set a queue length limit associated with a queue stored in the shared memory to an initial value; and
increase the queue length limit in response to a predetermined condition.

26. The line interface unit of claim 25, wherein the only adjustment to the queue length limit occurs when the initial queue length limit is set and when the queue length limit is increased in response to the predetermined condition.

27. The line interface unit of claim 25, ATM mapping device is configured to increasing increase the queue length limit by a fixed amount in response to the predetermined condition.

28. The line interface unit of claim 25, wherein the ATM mapping device is further configured to:
determine if the queue length limit is less than or equal to a maximum queue length;
increase the queue length limit if the queue length limit is less than or equal to the maximum queue length.

29. The line interface unit of claim 25, wherein the predetermined condition is an overflow condition.

30. The line interface unit of claim 29, wherein the ATM mapping device is configured to generate an interrupt in response to the overflow condition.

31. The line interface unit of claim 30, wherein the ATM mapping device is configured to execute an interrupt service routine in response to the interrupt.

32. The line interface unit of claim 31, wherein the interrupt service routine increases the queue length limit in response to the overflow condition.

33. The line interface unit of claim 25, wherein the ATM mapping device is configured to poll a memory location containing data indicative of whether the predetermined condition exists.

34. The line interface unit of claim 25, wherein the predetermined condition is a condition indicating that an overflow condition is likely to occur.

35. The line interface unit of claim 25, wherein the ATM mapping device comprises a inverse multiplexer.

36. The line interface unit of claim 35, wherein:
the TDM bus interface device is adapted to receive and transmit data with a plurality of TDM lines; and
the ATM mapping device is configured to map cells directly to the plurality of TDM lines.

37. The line interface unit of claim 25, wherein the at least one TDM line includes one of the following: an E1 line and a T1 line.

38. The line interface unit of claim 25, wherein the TDM interface is configured to communicate with the at least one TDM line over a TDM bus.

39. The line interface unit of claim 25, further comprising:
a plain old telephone service circuit in communication with the splitter and the TDM bus interface; and
a splitter in communication with the ADSL interface device and the plain old telephone service circuit on an upstream side and adapted to communicate with the at least one ADSL line on a downstream side.

40. The line interface unit of claim 25, further comprising:
a header translation device in communication with the ATM mapping device.

41. The line interface unit of claim 25, wherein the ATM mapping device is configured to:
increase the queue length limit of a plurality of queues in response to the predetermined condition.
